(19) United States
(12) Patent Application Publication
(10) Pub. No.: US 2020/0227811 A1
(43) Pub. Date: Jul. 16, 2020

(54) MINIATURIZED RF FRONT END MODULES

(71) Applicant: INTEL CORPORATION, Santa Clara, CA (US)

(72) Inventors: SIDHARTH DALMIA, Portland, OR (US); JONATHAN C. JENSEN, Portland, OR (US); TRANG THAI, Hillsboro, OR (US); OZGUR INAC, Hillsboro, OR (US)

(73) Assignee: INTEL CORPORATION, Santa Clara, CA (US)

(21) Appl. No.: 16/249,559

(22) Filed: Jan. 16, 2019

(51) Int. Cl. H01Q 1/22; H01Q 5/364; H01Q 9/04

(52) U.S. Cl. CPC H01Q 1/2283; H01Q 9/0407; H01Q 5/364

(57) ABSTRACT

An RF transceiver device, for use in an RF system, includes a chip package comprising one or more circuit components, a signal cable, and an antenna block. The signal cable is configured to carry signals sent to the chip package or received from the chip package. The signal cable has a first surface and a second surface. The chip package is directly coupled to the first surface of the signal cable. The antenna block comprises one or more antennas and is directly coupled to the second surface of the signal cable. By directly coupling the chip package and antenna block to the signal cable, bulky connectors are no longer needed thus reducing the total footprint of the transceiver device and increasing signal fidelity. The arrangement may be integrated with, for example, a PCB or a communication system.

### BACKGROUND

Wireless communication devices, such as handheld computing devices and wireless access points, include antennas. The frequencies over which communication may occur may depend on the shape and arrangement of an antenna or antenna array, among other factors. The quality of the communication signal depends on many factors, which may include the arrangement and size of components sharing the same board with the antenna or antenna array.

### BRIEF DESCRIPTION OF THE DRAWINGS

Features and advantages of embodiments of the claimed subject matter will become apparent as the following Detailed Description proceeds, and upon reference to the Drawings, in which:

FIG. 1 illustrates a communication module for use in a communication device.

FIG. 2 illustrates a portion of the architecture of an example communication device.

FIG. 3A illustrates a side view of a signal cable coupled to a radio frequency integrated circuit (RFIC), in accordance with an embodiment of the present disclosure.

FIG. 3B illustrates a top view of the signal cable coupled to the radio frequency integrated circuit (RFIC), in accordance with an embodiment of the present disclosure.

FIG. 4A illustrates a side view of a signal cable coupled to a radio frequency integrated circuit (RFIC) and a circuit board, in accordance with an embodiment of the present disclosure.

FIG. 4B illustrates a top view of the signal cable coupled to the radio frequency integrated circuit (RFIC) and the circuit board, in accordance with an embodiment of the present disclosure.

FIG. 5 illustrates a signal cable bent at an angle, in accordance with an embodiment of the present disclosure.

FIG. 6 illustrates a signal cable having devices on multiple faces, in accordance with some embodiments of the present disclosure.

FIG. 7 illustrates a portion of the architecture of an example communication device, in accordance with an embodiment of the present disclosure.

FIG. 8 illustrates a portion of the architecture of another example communication device, in accordance with some embodiments of the present disclosure.

FIG. 9 illustrates a portion of the architecture of another example communication device, in accordance with some embodiments of the present disclosure.

FIG. 10 illustrates an RFIC chip package, in accordance with some embodiments of the present disclosure.

FIG. 11 illustrates the RFIC chip package of FIG. 10 with a heat extractor, in accordance with some embodiments of the present disclosure.

FIG. 12 illustrates a block diagram of an example communication device that may include one or more signal routing cables, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

A radio frequency (RF) transceiver device, for use in an RF system, includes a chip package comprising one or more circuit components, a signal cable, and an antenna block. The signal cable is configured to carry signals sent to the chip package and/or received from the chip package. The signal cable has a first surface and a second surface. The second surface may be, for instance, an opposite, parallel second surface with respect to the first surface. The signal cable may include any number of surfaces arranged in a number of ways, as will be appreciated in light of this disclosure. The chip package is directly coupled to the first surface of the signal cable. The antenna block comprises one or more antennas and is directly coupled to the second surface of the signal cable. By directly coupling the chip package and antenna block to the signal cable, bulky connectors are no longer needed thus reducing the total footprint of the transceiver device and increasing signal fidelity. Numerous embodiments, variations, and applications will be appreciated.

General Overview

RF communication at high frequencies (e.g., in excess of 1 GHz, such as 5 GHz or 60 GHz) can be sensitive to the arrangement of the specific components on a given RFIC. Typically, connector cables such as flexible ribbon cables or coaxial cables make electrical connection with a printed circuit board (PCB) via one or more connectors. These connectors provide an interface for routing signals from the conductive lines of the connector cables to the conductive traces on the PCB. In some communication devices, numerous RFIC chip packages may be spread across different PCBs, thus requiring the use of many connectors to provide electrical connection between each of the different PCBs, or between the PCBs back to a primary PCB (e.g., a motherboard). Each connector takes up a relatively large amount of real estate on a board and also can cause other signal-related problems. For example, signal loss can occur at the connector as the signals transition between the cable conductors and conductors on the PCB. The connectors can also cause electromagnetic interference (EMI) with the RF signals being sent/received by nearby antennas. The connectors also can cause RF oscillations to occur in the signal lines, thus degrading the RF signal quality.

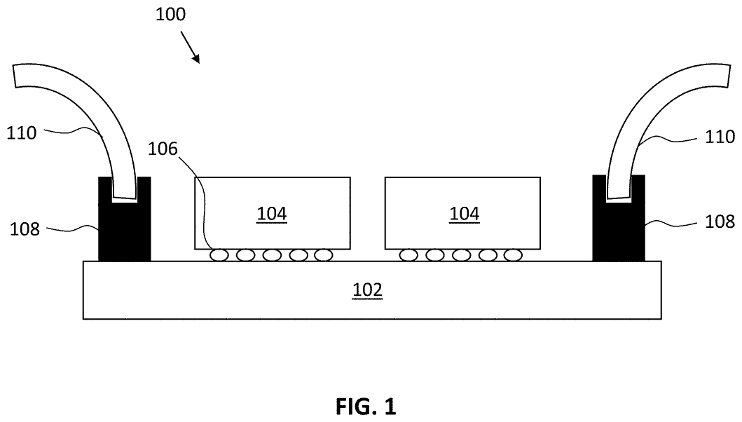

FIG. 1 illustrates an example RF module 100 that includes an RF board 102 having one or more RFIC chip packages 104. Each RFIC chip package 104 is conductively coupled to RF board 102 via one or more conductive pathways 106. RF board 102 also includes one or more connectors 108 to provide electrical connections for one or more signal cables 110 that send/receive signals to/from one or more RFIC chip packages 104. RF module 100 also includes antennas or antenna arrays (not illustrated) that are located on either the front surface of RF board 102 (e.g., the same surface with RFIC packages 104) or on the opposite back surface of RF board 102. As can be further seen, connectors 108 may be pin connectors having 8, 16, 20, or 40 pins for connecting to a corresponding connector at the end of signal cables 110. The larger the number of pins, the more space connector 108 takes up on RF Board 102. Furthermore, the relatively large dimensions of connectors 108 compared to other electrical components present on RF Board 102 can cause issues with signal fidelity or blocking of RF signals being sent to or received from the antennas.

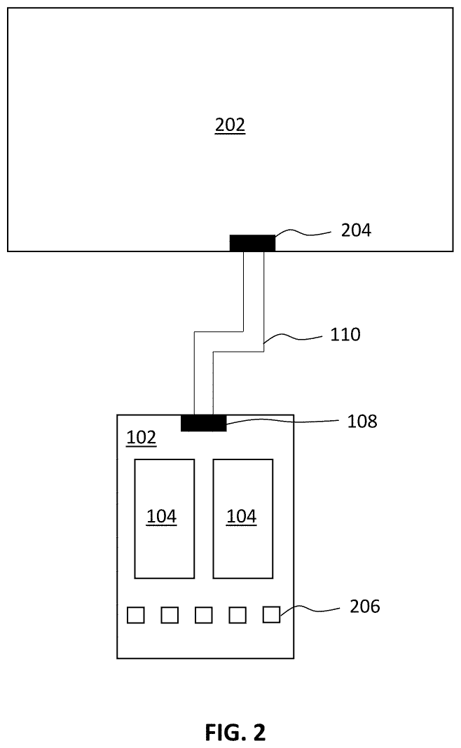

FIG. 2 illustrates an example portion of an RF device architecture having a primary circuit board 202 connected to an RF board 102 via signal cable 110. Primary circuit board 202 also includes a connector 204 to make electrical connection with signal cable 110. An antenna array 206 is also illustrated on RF board 102 and may be located on either the front or back surface of RF board 102 as discussed above. Primary circuit board 202 can include any number of ICs designed to filter or provide analog-to-digital (ADC) conversion of the RF signals. Digital front end circuitry may also be provided on primary circuit board 202 to process the digital signals into useful signals for other components of an electronic device that includes the RF device architecture. Devices may include any number of RF boards 102, each connected to one or more primary circuit boards 202, or connected to one another, via signal cables 110. Accordingly, the total number of connectors 108/204 required in a given device can be very large, which can negatively impact the form factor of the device and signal fidelity, especially at higher signal frequencies (e.g., around 60 GHz.)

Thus, various example embodiments described herein effectively remove connectors in the RF device architecture by directly coupling the signal cable conductors to the conductive pathways of one or more RFIC chip packages. Antenna array blocks may also be coupled directly to the signal cables, according to some such embodiments. In some such example embodiments, the RF board is no longer needed as part of the RF device architecture, as the IC components and antenna array components are directly coupled to one or more signal cables.

Some of the example embodiments described herein use RFIC chip packages with an exposed die design such that the RFIC die within the package has a surface in direct contact with a conductive casing around the chip package. The exposed die design allows for better thermal management of the RFIC die, a smaller overall package, and increased signal fidelity, according to some such embodiments.

According to another embodiment, an RF system includes a chip package, a board, a connector cable, and an antenna block. The chip package includes one or more circuit components configured to transmit and/or receive RF signals and the board includes one or more circuit components configured to process signals sent to the chip package and/or received from the chip package. The connector cable is configured to carry the signals sent to the chip package and/or received from the chip package. The connector cable has a first surface and an opposite, parallel second surface, and the chip package is directly coupled to the first surface of the connector cable. The antenna block includes one or more antennas and is directly coupled to the second surface of the connector cable. Numerous variations that efficiently leverage surfaces of the connector cable will be appreciated.

Connectorless Cable Architecture

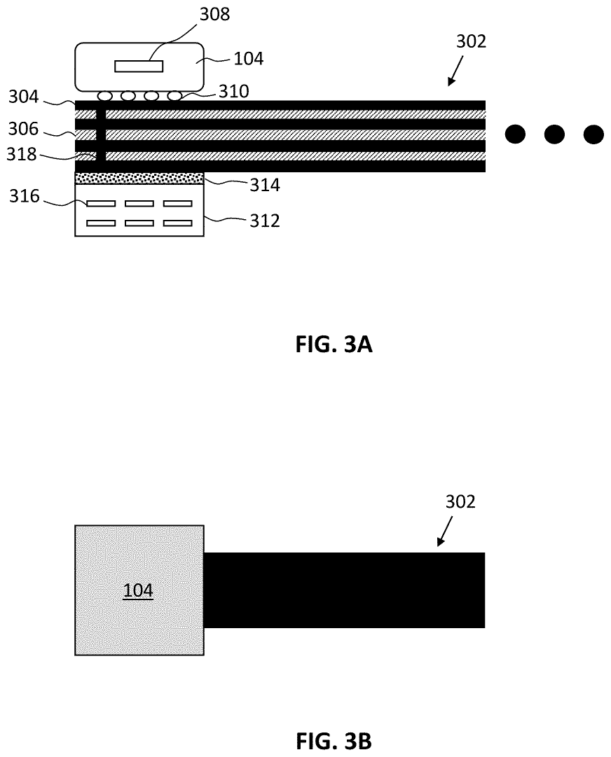

FIG. 3A illustrates a side view of a signal cable 302 coupled directly to an RFIC chip package 104, according to an embodiment. As used herein, the term “coupled directly” or “directly coupled” means that the components are in physical contact with one another. Signal cable 302 may be any type of cable that can carry an RF signal. Some examples of signal cable 302 include ribbon cables having a plurality of conductive lines, and coaxial cables.

According to an embodiment, signal cable 302 includes one or more conductive layers 304 alternating with one or more dielectric layers 306. One or more conductive layers 304 may be metal, such as copper, gold, aluminum, or silver to name a few examples. One or more dielectric layers 306 may be any dielectric material suitable for electrically isolating different levels of conductive layers 304 from one another. In one example, dielectric layers 306 comprise a liquid crystalline polymer. Other example materials for dielectric layers 306 include polyimide, polyester, polyethylene terephthalate, polyether ether ketone, etc. Four levels of conductive layers 304 and three levels of dielectric layers 306 are provided for illustrative purposes only, and any number of conductive layer 304 and dielectric layers 306 may be used in signal cable 302. A total thickness of signal cable 302 may be such that signal cable 302 can bend with relative ease without fracturing any of conductive layers 304 or dielectric layers 306. For example, signal cable 302 may have a thickness between 350 μm and 550 μm. It is not required for the entire length of signal cable 302 to be flexible. For example, in some embodiments, signal cable 302 may include rigid portions and flexible portions along its length.

RFIC chip package 104 includes one or more RFIC chips 308. RFIC chip package 104 can be any standard chip package and the present embodiments are not limited by the design of RFIC chip package 104. Any RFIC chip 308 may include circuitry designed to modulate or demodulate RF signals, provide frequency filtering of the signals, or provide any other signal conditioning. Accordingly, one or more RFIC chips 308 can include any number of resistors, capacitors (e.g., decoupling capacitors), inductors, DC-DC converter circuitry, or other circuit elements. In some embodiments, the RFIC chip package 104 may be a system-in-package (SiP). In some embodiments, RFIC chip package 104 may be a flip chip (FC) chip scale package (CSP). In some embodiments, one or more RFIC chips 308 may include a memory device programmed with instructions to execute beam forming, scanning, and/or codebook functions.

According to an embodiment, RFIC chip package 104 makes electrical contact with connector cable 302 via conductive contacts 310. In some embodiments, conductive contacts 310 include a solder ball grid array (BGA). Other examples of conducive contacts 310 include pin grid arrays, solder bumps, wire bonds, conductive underfill, etc. According to an embodiment, conductive contacts 310 provide direct conductive coupling to one or more of conductive layers 304 in signal cable 302. For the purposes of this disclosure, conductive contacts 310 are a part of RFIC chip package 104, such that RFIC chip package 104 is in direct contact with signal cable 302. In some embodiments, conductive contacts 310 each contact a top conductive layer of conductive layers 304. In some embodiments, different ones of conductive contacts 310 may contact different layers of conductive layers 304. Electrical signals are routed between one or more RFIC chips 308 and the one or more conductive layers 304 of signal cable 302 via conducive contacts 310.

According to an embodiment, an antenna block 312 is also directly coupled to signal cable 302 via a material layer 314. For the purposes of this disclosure, material layer 314 is a part of antenna block 312, such that antenna block 312 is in direct contact with signal cable 302. Antenna block 312 may have a thickness between 500 μm and 1000 μm. Antenna block 312 may be a PCB or any other insulative substrate that includes an antenna array 316. Antenna block 312 may include any suitable dielectric material. In some embodiments, antenna block 312 may include an organic dielectric material, a fire retardant grade 4 material (FR-4), bismaleimide triazine (BT) resin, polyimide materials, glass reinforced epoxy matrix materials, or low-k and ultra low-k dielectric (e.g., carbon-doped dielectrics, fluorine-doped dielectrics, porous dielectrics, and organic polymeric dielectrics).

Antenna array 316 may include a plurality of patch antennas or microstrip antennas. Any number of antennas may be included in antenna array 316. In some embodiments, antenna array 316 may include one or more antennas to support multiple communication bands (e.g., dual band operation or tri-band operation). For example, some of the antennas may support tri-band operation at 28 gigahertz, 39 gigahertz, and 60 gigahertz. Various ones of the antennas may support tri-band operation at 24.5 gigahertz to 29 gigahertz, 37 gigahertz to 43 gigahertz, and 57 gigahertz to 71 gigahertz. Various ones of the antennas may support 5G communications and 60 gigahertz communications. Various ones of the antennas may support 28 gigahertz and 39 gigahertz communications. Various ones of the antennas may support millimeter wave communications. Various ones of the antennas may support high band frequencies and low band frequencies.

According to an embodiment, antenna block 312 is directly coupled to signal cable 302 via a material layer 314. Material layer 314 may extend over an entire surface of antenna block 312, or many extend over a portion of antenna block 312. Material layer 314 may be either a conductive or insulative adhesive material. In some other embodiments, material layer 314 is a solder material. Regardless of the conductivity of material layer 314, the antennas of antenna array 316 may not have a conductive electrical coupling to signal cable 302 or to RFIC chip package 104.

In some embodiments, the inductive coupling of electromagnetic energy to/from antenna array 316 to/from RFIC chip package 104 is aided by the use of conductive vias 318 extending through a thickness of signal cable 302. Any number of conductive vias 318 may be used. Additionally, conductive vias 318 may be placed adjacent to the location of RFIC chip package 104, or adjacent to the location of antenna block 312 along the length of signal cable 302. In one embodiment, RFIC chip package 104 is coupled to a first side of signal cable 302 and antenna block 312 is coupled on a second opposite side of signal cable 302, and opposite to RFIC chip package 104 along the length of signal cable 302. Any number of RFIC chip packages 104 may be coupled to the first or second side of signal cable 302 along the length of signal cable 302. Similarly, any number of antenna blocks 312 may be coupled to the first or second side of signal cable 302 along the length of signal cable 302.

FIG. 3B illustrates a top-down view of signal cable 302 coupled directly to RFIC chip package 104, according to an embodiment. As shown in FIG. 3B, RFIC chip package 104 may have a width dimension that is wider than the width of signal cable 302. For example, signal cable 302 may have a width between about 3 mm and about 7 mm, and RFIC chip package 104 may have a width between about 5 mm and about 10 mm. RFIC chip package 104 may have a length between about 20 mm and about 25 mm. The length of signal cable 302 may range between about 100 mm and about 500 mm. In an embodiment, antenna block 312 is smaller than RFIC chip package 104 and is thus obscured from the top-down view by RFIC chip package 104.

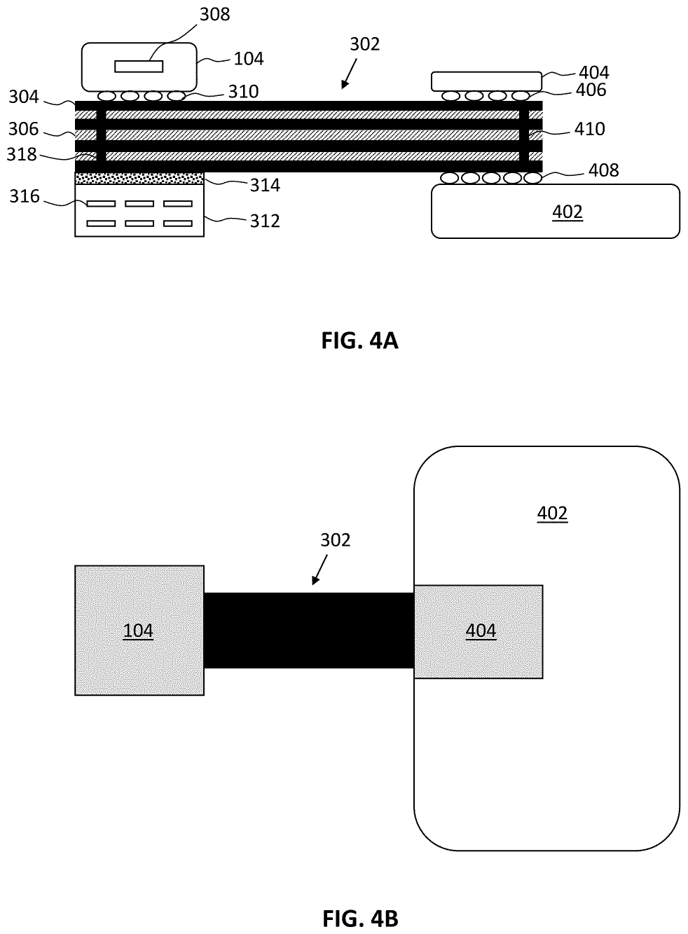

FIG. 4A illustrates a side view of signal cable 302 that also shows the connection of signal cable 302 to a board 402, according to an embodiment. FIG. 4B illustrates a top-down view of signal cable extending between RFIC chip package 104 and board 402. Board 402 may be any known type of circuit board that may include traces, vias, and other structures formed of an electrically conductive material (e.g., a metal, such as copper). The conductive structures in board 402 may be electrically insulated from each other by a dielectric material. Any suitable dielectric material may be used (e.g., a laminate material). In some embodiments, the dielectric material may be an organic dielectric material, a fire-retardant grade 4 material (FR-4), bismaleimide triazine (BT) resin, polyimide materials, glass reinforced epoxy matrix materials, or low-k and ultra low-k dielectric (e.g., carbon-doped dielectrics, fluorine-doped dielectrics, porous dielectrics, and organic polymeric dielectrics). Board 402 may include any number of passive circuit elements (e.g., resistors, capacitors, inductors, etc.) Additionally, board 402 may include any number of IC chip packages mounted to it. The ICs on board 402 may be used to filter or provide analog-to-digital (ADC) conversion of the RF signals. Digital front end circuitry may also be provided on board 402 to process the digital signals into useful signals for other components of an electronic device. In some embodiments, one or more IC chip packages 404 may be directly coupled to signal cable 302 via conductive contacts 406. One or more IC chip packages 404 may be ICs that would normally have been placed on board 402 but have been moved to couple directly to signal cable 302, according to some embodiments. In some embodiments, board 402 is substantially larger than either RFIC chip package 104 or one or more IC chip packages 404.

In some embodiments, conductive contacts 406 include a solder ball grid array (BGA). Other examples of conducive contacts 406 include pin grid arrays, solder bumps, wire bonds, conductive underfill, etc. According to an embodiment, conductive contacts 406 provide direct conductive coupling to one or more of conductive layers 304 in signal cable 302. In some embodiments, conductive contacts 406 each contact a top conductive layer of conductive layers 304. In some embodiments, different ones of conductive contacts 406 may contact different layers of conductive layers 304. Electrical signals are routed between one or more IC chip packages 404 and the one or more conductive layers 304 of signal cable 302 via conducive contacts 406.

Board 402 may be directly coupled to signal cable 302 via conductive contacts 408, which may be like any of the previous conductive contacts already described. In some embodiments, signal cable 302 is coupled to board 402 via a standard pin connector. In some embodiments, board 402 is a primary circuit board (or “motherboard”) that connects out to one or more other boards or ICs via one or more signal cables.

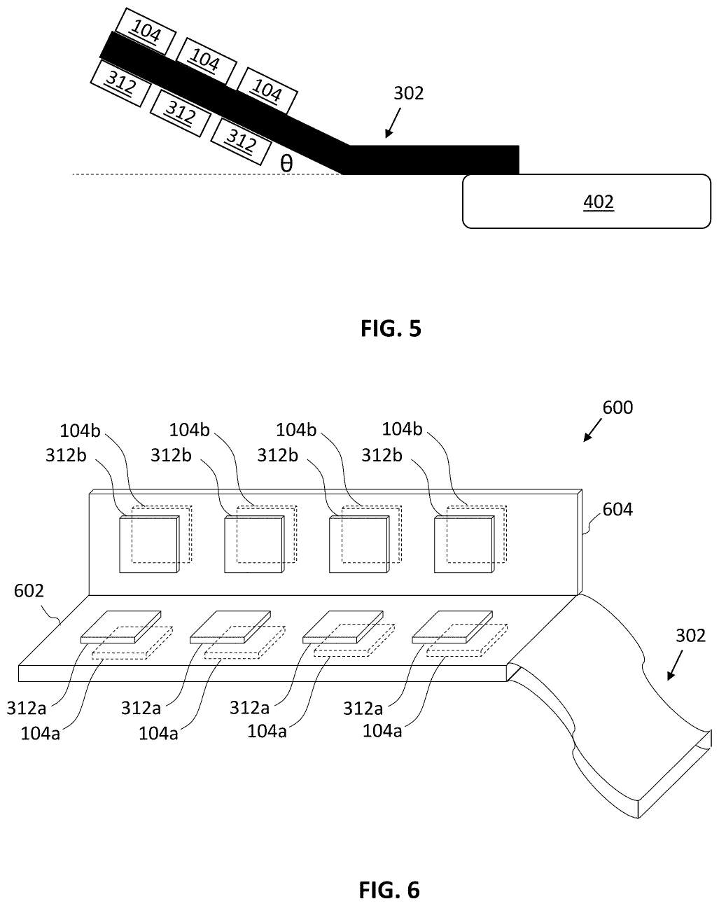

FIG. 5 illustrates an example signal cable 302 having a plurality of RFIC chip packages 104 and antenna blocks 312 directly coupled to it. According to some embodiments, each RFIC chip package 104 is aligned over a corresponding antenna block 312. This 1:1 alignment of RFIC chip packages 104 to antenna blocks 312 simplifies the routing of conductive traces and/or vias to carry signals between chip packages 104 and antenna blocks 312. The simpler routing design can lead to enhanced signal fidelity.

Signal cable 302 may be directly coupled to board 402, although in some embodiments, signal cable 302 is connected to board 402 using standard pin connectors. According to an embodiment, signal cable 302 is bent at an angle θ with respect to board 402, such that each of RFIC chip packages 104 and antenna blocks 312 is also disposed at an angle θ with respect to board 402. Due to the flexible nature of signal cable 302, angle θ may be any angle between −90 degrees and +90 degrees. In some embodiments, signal cable 302 is bent into a ‘U’ shape such that RFIC chip packages 104 and antenna blocks 312 are aligned along a plane that is parallel to the side of board 402 but separated from board 402 by a distance. Although separate antenna blocks 312 are illustrated in FIG. 5, in some embodiments, a single antenna block 312 having a plurality of antenna arrays stretches across a length of signal cable 302 on the opposite side of a plurality of RFIC chip packages 104.

The ability to align RFIC chip packages 104 and antenna blocks 312 at any angle may be advantageous in certain circumstances. As electronic devices become smaller, fitting components into smaller form factors becomes increasingly important. The ability to bend and wrap signal cable 302 in different directions allows for multiple components to fit into a smaller form factor. Furthermore, antenna blocks 312 may be bent to align in any direction thus enhancing the signal quality when receiving signals coming from a particular direction, or when transmission is desired to be strongest in a given direction.

Signal cable 302 may be bent at multiple locations along its length. According to some embodiments, various RFIC chip packages 104 and antenna blocks 312 may be located at different angles with respect to board 402 depending on their position along signal cable 302. RFIC chip packages 104 and antenna blocks 312 may be located on either side of signal cable 302. In some embodiments, booster amplifiers may be included along the length of signal cable 302 to ensure that RF signals received at different components on signal cable 302 remain strong as they propagate along signal cable 302 and between the various components.

Signal cable 302 may include more than one surface bent at a given angle to provide more sides for coupling RFIC chip packages 104 and antenna blocks 312. FIG. 6 illustrates an example non-planar antenna module 600 including signal cable 302 that has a first surface 602, and a second surface 604 bent at an angle with respect to first surface 602. The angle may be substantially 90 degrees, as illustrated in FIG. 6, although any angle may be used. In an embodiment, the surfaces are movable such that second surface 604 can flex, bend, or rotate about its edge that attaches to first surface 602. Similarly, first surface 602 can flex, bend, or rotate about its edge that attaches to second surface 604. Two surfaces are illustrated for convenience, but any number of surfaces can be used in a single signal cable 302.

Each of first surface 602 and second surface 604 may include any number of RFIC chip packages 104 and antenna blocks 312 in any configuration and arranged on either side of each of first surface 602 and second surface 604. In the illustrated embodiment, first surface 602 includes a plurality of antenna blocks 312a on a first side and a plurality of RFIC chip packages 104a on a second side. Each of RFIC chip packages 104a may be substantially aligned with a corresponding antenna block 312a through first surface 602. Similarly, second surface 604 includes a plurality of antenna blocks 312b on a first side and a plurality of RFIC chip packages 104b on a second side. Each of RFIC chip packages 104b may be substantially aligned with a corresponding antenna block 312b through second surface 604.

According to an embodiment, antenna blocks 312a may include antennas having different structures than the antennas of antenna blocks 312b. For example, low band antennas operable over a first frequency range may be used in antenna blocks 312a while high band antennas operable over a second, higher frequency range may be used in antenna blocks 312b. The combinatorial use of both low band antennas and high band antennas increases the usable frequency bandwidth of the system. In one embodiment, the first frequency range is between 24 GHz and 31 GHz, and the second frequency range is between 37 GHz and 48 GHz. Generally, dimensionally smaller antennas may be used to operate at higher frequencies.

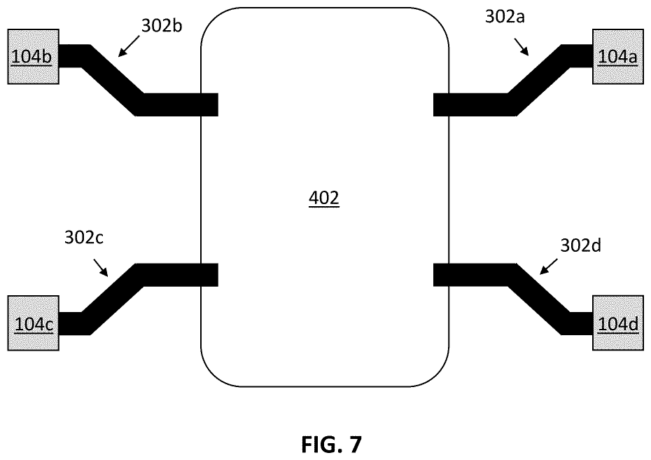

Non-planar antenna module 600 may be positioned in any desired configuration within a communication device, such as any of the communication devices described herein with reference to FIGS. 7-9. More generally, non-planar antenna module 600 may be mounted in an electronic component in a non-coplanar configuration, allowing antenna blocks 312 on different surfaces of signal cable 302 to radiate and receive at different angles or allowing antenna blocks 312 to radiate and receive at an angle that is different from the nominal “planar” arrangement. In some embodiments, two or more non-planar antenna modules 600 can be used and oriented at different angles with respect to each other to increase the signal coverage across a range of frequencies. In one example, a first non-planar antenna module may be flipped 90 degrees with respect to a second non-planar antenna module such that the low band antennas of the first non-planar antenna module are oriented 90 degrees with respect to the low band antennas of the second non-planar antenna module, and the high band antennas of the first non-planar antenna module are oriented 90 degrees with respect to the high band antennas of the second non-planar antenna module. The first non-planar antenna module may be oriented anywhere between −90 degrees and +90 degrees with respect to the second non-planar antenna module.

FIG. 7 illustrates an example RF architecture that may be included within an electronic device. Board 402 is illustrated having a plurality of different signal cables 302a-302d. Each of signal cables 302a-302d is directly coupled to a corresponding RFIC chip package 104a-104d. Each of signal cables 302a-302d may also include any number of other RFIC chip packages or antenna blocks 312 anywhere along its length.

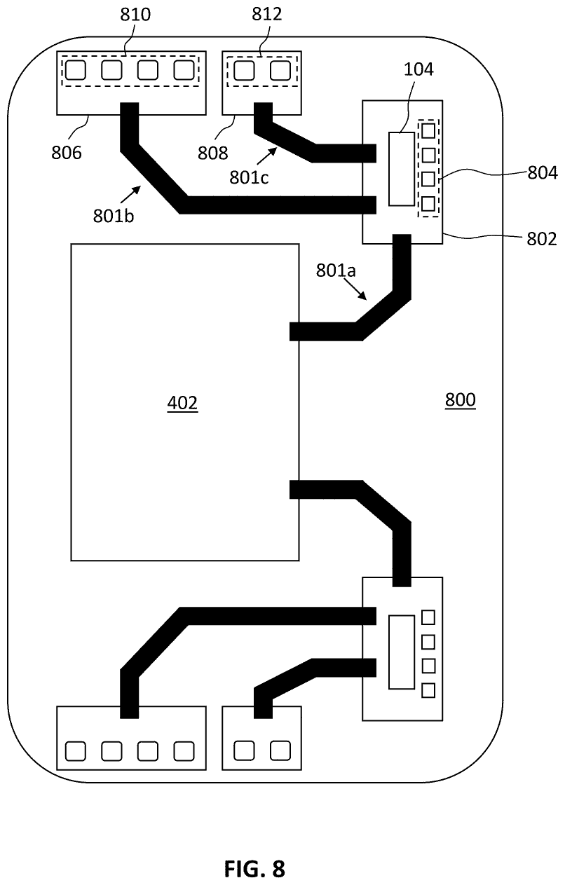

FIG. 8 illustrates another example RF architecture included within an electronic device 800. Electronic device 800 may be any device that sends and/or receives RF signals. Examples of electronic device 800 include a cell phone, a smart phone, a mobile internet device, a music player, a tablet computer, a laptop computer, a netbook computer, an ultrabook computer, a personal digital assistant (PDA), an ultra mobile personal computer, etc.), a desktop communication device, a server or other networked computing component, a printer, a scanner, a monitor, a set-top box, an entertainment control unit, a vehicle control unit, a digital camera, a digital video recorder, or a wearable communication device. Electronic device 800 includes one or more primary boards 402 having multiple signal cables for routing signals to and from primary board 402 to and from one or more other boards.

According to an embodiment, electronic device 800 includes one or more RF boards 802. Each of RF boards 802 may include any of the same materials and structure as described above for board 402. A single RF board 802 will be referenced herein for clarity but may apply to any RF board included in electronic device 800. RF board 802 may include one or more RFIC chip packages 104 and an antenna array 804. Antenna array 804 may include a beam pattern scanning (BPS) antenna array. As discussed previously, one or more RFIC chip packages 104 may be located on a first side of RF board 802 and antenna array 804 may be located on an opposite second side of RF board 802. Signal cable 801a may be directly coupled to RF board 802 without the use of a connector as discussed above with reference to FIGS. 3 and 4. Similarly, signal cables 801b and 801c may each be directly coupled to RF board 802 without the use of a connector.

According to some embodiments, signal cable 801a transfers signals between RF board 802 and primary board 402, signal cable 801b transfers signals between RF board 802 and an antenna board 806, and signal cable 801c transfers signals between RF board 802 and an antenna board 808. Signal cable 801b may be directly coupled to antenna board 806. Signal cable 801c may be directly coupled to antenna board 808. Each of antenna boards 806 and 808 includes any of the same materials and structure as described above for board 402.

According to an embodiment, antenna board 806 includes a 1×4 antenna array 810 that includes four distinct antenna chip packages. According to an embodiment, antenna board 808 includes a 1×2 antenna array 812 that includes two distinct antenna chip packages. Any number of antenna boards may be coupled to RF board 802 via signal cables directly coupled between a corresponding antenna board and RF board 802. Additionally, each of the antenna boards may include any number of antenna chip packages. Each antenna chip package may be similar to antenna block 312 as described above in FIG. 3.

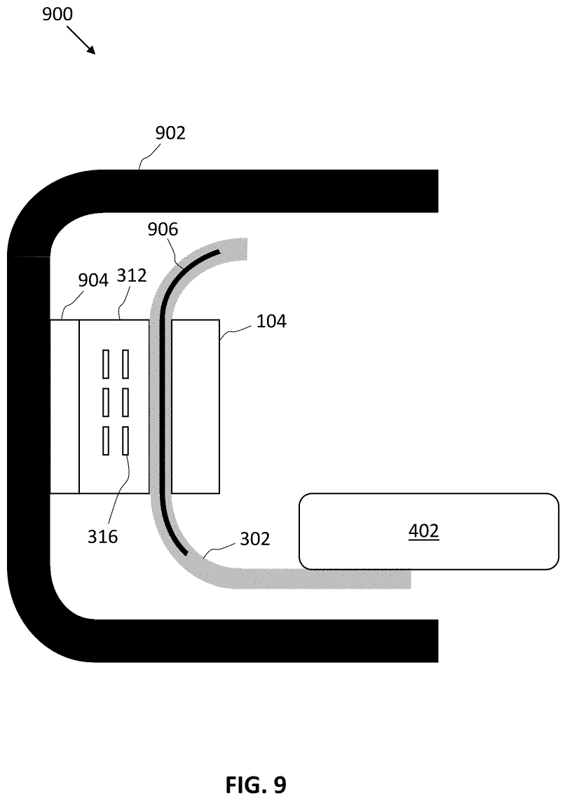

FIG. 9 illustrates an example arrangement of a signal cable 302 within an electronic device 900, according to an embodiment. Signal cable 302 may be directly coupled to one or more RFIC chip packages 104 and one or more antenna blocks 312 as discussed above in FIG. 3.

According to an embodiment, electronic device 900 includes a casing 902, and antenna block 312 may be coupled to an interior surface of casing 902 using an adhesive 904. Adhesive 904 may extend over an entire surface of antenna block 312, or many extend over a portion of antenna block 312. Adhesive 904 may be either a conductive or insulative adhesive material. In some other embodiments, adhesive 904 is an epoxy. A thickness of adhesive 904 may be controlled based on the application and communication frequency used by antenna array 316.

Adhesive 904 may be used to attach antenna block 312 to any interior surface of casing 902 at any orientation. In some embodiments, adhesive 904 attaches RFIC chip package 104 to any interior surface of casing 902 at any orientation. In some embodiments, casing 902 defines the edges of a cellular phone or a smart phone.

According to an embodiment, a conductor 906 that extends at least a length of signal cable 302 beneath antenna block 312 acts as a ground plane for antenna array 316. Conductor 906 may extend through signal cable 302 further than the length of antenna block 312 on either side of antenna block 312. By running the antenna ground through signal cable 302, the ground plane can remain large in comparison to antenna array 316, which may increase the bandwidth of antenna array 316.

Exposed-Die Packaging

As discussed above, using a connectorless design helps to miniaturize RF architecture for use in electronic devices with smaller form factors. Another design that can miniaturize RF architecture is to change the way that RFICs are packaged. According to an embodiment, an RFIC is packaged using an exposed-die design such that one surface of the RFIC chip contacts the conductive shield around the outside of the package, thus eliminating any mold material over the RFIC chip.

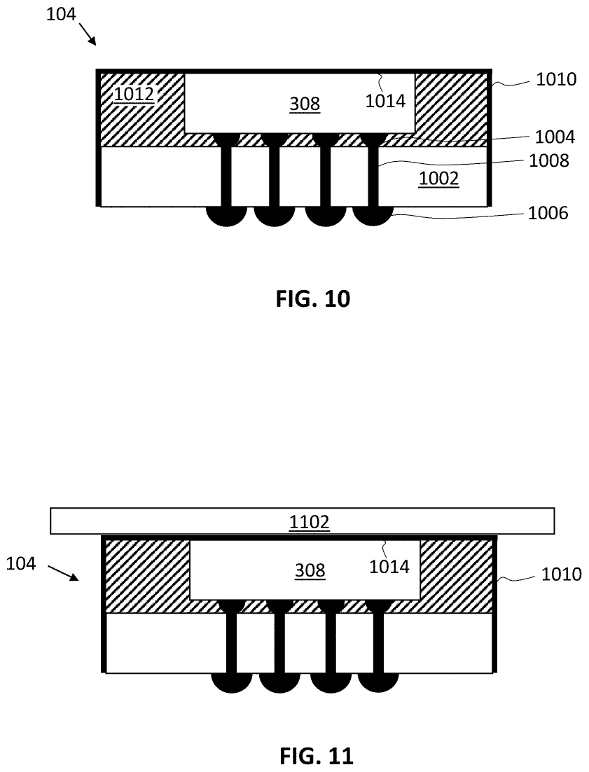

FIG. 10 illustrates an example of RFIC chip package 104 having RFIC chip 308 coupled to a package substrate 1002, according to an embodiment. RFIC chip 308 may be coupled to package substrate 1002 using first-level interconnects 1004. In particular, conductive contacts at one face of package substrate 1002 may be coupled to conductive contacts at faces of RFIC chip 308 by first-level interconnects 1004. In the illustrated embodiment, first-level interconnects 1004 are solder bumps, but any suitable first-level interconnects 1004 may be used (e.g., pins in a pin grid array arrangement or lands in a land grid array arrangement). In some embodiments, a solder resist is disposed between first-level interconnects 1004.

Package substrate 1002 may include a dielectric material, and may have conductive pathways (e.g., including conductive vias and lines) extending through the dielectric material between the faces, or between different locations on each face. In some embodiments, package substrate 1002 may have a thickness less than 1 millimeter (e.g., between 0.1 millimeters and 0.5 millimeters). Additional conductive contacts may be disposed at an opposite face of package substrate 1002 for conductively contacting second-level interconnects 1006. One or more vias 1008 extend through a thickness of package substrate 1002 to provide conductive pathways between one or more of first-level interconnects 1004 to one or more of second-level interconnects 1006. Vias 1008 are illustrated as single straight columns through package substrate 1002 for ease of illustration and, in some embodiments, vias 1008 are fabricated by multiple smaller stacked vias, or are staggered at different locations across package substrate 1002. Second-level interconnects 1006 may be used to electrically connect the components of RFIC chip package 104 to other conductive contacts on, for example, a circuit board. In the illustrated embodiment, second-level interconnects 1006 are solder balls (e.g., for a ball grid array arrangement), but any suitable second-level interconnects 1006 may be used (e.g., pins in a pin grid array arrangement or lands in a land grid array arrangement). In some embodiments, a solder resist is disposed between second-level interconnects 1006.

RFIC chip package 104 includes a housing 1010 that encompasses and protects all the components of the package. In some embodiments, housing 1010 provides electromagnetic shielding and environmental protection for the components of RFIC chip package 104. In some embodiments, a mold material 1012 may be disposed around RFIC chip 1012 included within housing 1010 (e.g., as an underfill material). In some embodiments, a thickness of mold material 1012 may be less than 1 millimeter. Example materials that may be used for mold material 1012 include epoxy mold materials, as suitable.

According to an embodiment, mold material 1012 does not extend over a top surface 1014 of RFIC chip 308. Accordingly, top surface 1014 of RFIC chip 308 is “exposed” to housing 1010, and makes conductive contact with housing 1010, according to an embodiment. This design allows for better thermal management and heat dissipation from RFIC chip 308 through housing 1010. RFIC chip package 104 having this exposed die design may be used in any of the embodiments described herein without limitation. Accordingly, embodiments of miniaturized RF architecture may include having one or more RFIC chip packages with an exposed die design coupled directly to signal cables such that cable connectors are also eliminated.

FIG. 11 illustrates RFIC chip package 104 having a thermal extractor 1102 coupled to housing 1010. Thermal extractor 1102 may be coupled to a same side of housing 1010 that is also coupled to top surface 1014 of RFIC chip 308. In an embodiment, thermal extractor 1102 is a solid conductive material, such as a metal sheet, to act as a large heat sink and extract the heat generated from RFIC chip 308. In one example, thermal extractor 1102 is a graphite sheet.

In an embodiment, thermal extractor 1102 is a signal cable, such as signal cable 302 discussed in numerous embodiments herein. Signal cables include a plurality of conductive traces and/or vias, and thus may also act as a good thermal conduit for extracting heat generated from RFIC 308. In one example, the signal cable provides a thermal path from RFIC chip package 104 to a larger metal heat sink or to a PCB within an electronic device.

Example Communication Device

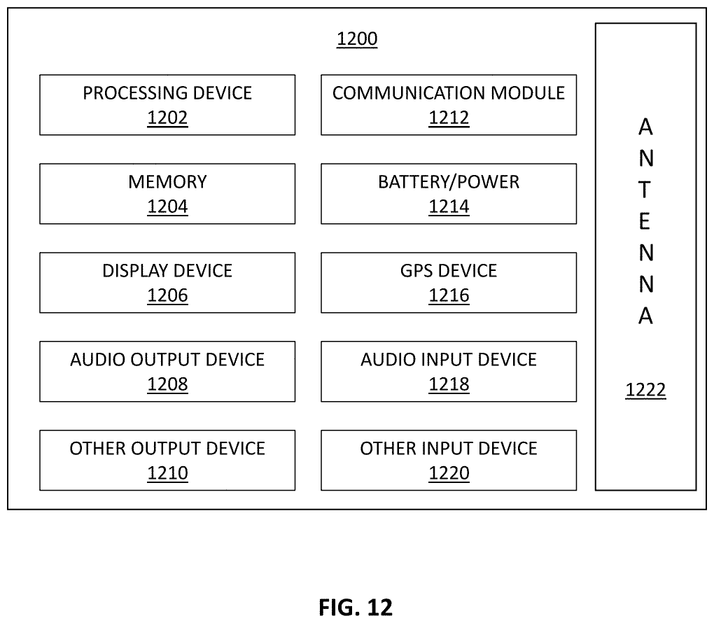

FIG. 12 is a block diagram of an example communication device 1200 that may include one or more signal cables for routing signals between various ICs and PCBs, in accordance with any of the embodiments disclosed herein. Any suitable ones of the components of the communication device 1200 may include one or more of the signal cables 302, RFIC chip packages 104, antenna blocks 312, and boards 402 disclosed herein. The signal cables used within communication device 1200 may be directly coupled to one or more of the RFIC chip packages 104, antenna blocks 312, and boards 402 included within communication device 1200. A number of components are illustrated in FIG. 12 as included in the communication device 1200, but any one or more of these components may be omitted or duplicated, as suitable for the application. In some embodiments, some or all of the components included in the communication device 1200 may be attached to one or more motherboards. In some embodiments, some or all of these components are fabricated onto a single system-on-a-chip (SoC) die.

Additionally, in various embodiments, communication device 1200 may not include one or more of the components illustrated in FIG. 12, but communication device 1200 may include interface circuitry for coupling to the one or more components. For example, communication device 1200 may not include a display device 1206, but may include display device interface circuitry (e.g., a connector and driver circuitry) to which display device 1206 may be coupled. In another set of examples, communication device 1200 may not include an audio input device 1218 or an audio output device 1208, but may include audio input or output device interface circuitry (e.g., connectors and supporting circuitry) to which audio input device 1218 or audio output device 1208 may be coupled.

Communication device 1200 may include a processing device 1202 (e.g., one or more processing devices). As used herein, the term “processing device” or “processor” may refer to any device or portion of a device that processes electronic data from registers and/or memory to transform that electronic data into other electronic data that may be stored in registers and/or memory. Processing device 1202 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. Communication device 1200 may include a memory 1204, which may itself include one or more memory devices such as volatile memory (e.g., dynamic random access memory (DRAM)), nonvolatile memory (e.g., read-only memory (ROM)), flash memory, solid state memory, and/or a hard drive. In some embodiments, memory 1204 may include memory that shares a die with processing device 1202. This memory may be used as cache memory and may include embedded dynamic random access memory (eDRAM) or spin transfer torque magnetic random access memory (STT-MRAM).

In some embodiments, communication device 1200 may include a communication module 1212 (e.g., one or more communication modules). For example, communication module 1212 may be configured for managing wireless communications for the transfer of data to and from communication device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Communication module 1212 may be, or may include, any of RFIC chip packages 104 or antenna blocks 312 disclosed herein.

Communication module 1212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), LTE project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. Communication module 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. Communication module 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication module 1212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication module 1212 may operate in accordance with other wireless protocols in other embodiments. Communication device 1200 may include an antenna 1222 to facilitate wireless communications and/or to receive other wireless communications (such as AM or FM radio transmissions).

In some embodiments, communication module 1212 may manage wired communications, such as electrical, optical, or any other suitable communication protocols (e.g., the Ethernet). As noted above, communication module 1212 may include multiple communication modules. For instance, a first communication module may be dedicated to shorter-range wireless communications such as Wi-Fi or Bluetooth, and a second communication module may be dedicated to longer-range wireless communications such as global positioning system (GPS), EDGE, GPRS, CDMA, WiMAX, LTE, EV-DO, or others. In some embodiments, the first communication module may be dedicated to wireless communications, and the second communication module may be dedicated to wired communications. In some embodiments, communication module 1212 may include one or more antenna blocks 312 that supports millimeter wave communication.

Communication device 1200 may include battery/power circuitry 1214. Battery/power circuitry 1214 may include one or more energy storage devices (e.g., batteries or capacitors) and/or circuitry for coupling components of communication device 1200 to an energy source separate from communication device 1200 (e.g., AC line power).

Communication device 1200 may include a display device 1206 (or corresponding interface circuitry, as discussed above). Display device 1206 may include any visual indicators, such as a heads-up display, a computer monitor, a projector, a touchscreen display, a liquid crystal display (LCD), a light-emitting diode display, or a flat panel display.

Communication device 1200 may include an audio output device 1208 (or corresponding interface circuitry, as discussed above). Audio output device 1208 may include any device that generates an audible indicator, such as speakers, headsets, or earbuds.

Communication device 1200 may include audio input device 1218 (or corresponding interface circuitry, as discussed above). Audio input device 1218 may include any device that generates a signal representative of a sound, such as microphones, microphone arrays, or digital instruments (e.g., instruments having a musical instrument digital interface (MIDI) output).

Communication device 1200 may include a GPS device 1216 (or corresponding interface circuitry, as discussed above). GPS device 1216 may be in communication with a satellite-based system and may receive a location of communication device 1200, as known in the art.

Communication device 1200 may include an output device 1210 (or corresponding interface circuitry, as discussed above). Examples of other output device 1210 may include an audio codec, a video codec, a printer, a wired or wireless transmitter for providing information to other devices, or an additional storage device.

Communication device 1200 may include an input device 1220 (or corresponding interface circuitry, as discussed above). Examples of other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Communication device 1200 may have any desired form factor, such as a handheld or mobile communication device (e.g., a cell phone, a smart phone, a mobile internet device, a music player, a tablet computer, a laptop computer, a netbook computer, an ultrabook computer, a personal digital assistant (PDA), an ultra mobile personal computer, etc.), a desktop communication device, a server or other networked computing component, a printer, a scanner, a monitor, a set-top box, an entertainment control unit, a vehicle control unit, a digital camera, a digital video recorder, or a wearable communication device. In some embodiments, the communication device 1200 may be any other electronic device that processes data.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Other embodiments may be implemented as software executed by a programmable control device. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood in light of this disclosure, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is an RF transceiver device. The RF transceiver device includes a chip package comprising one or more circuit components, a signal cable configured to carry signals sent to the chip package or received from the chip package, and an antenna block comprising one or more antennas. The signal cable has a first side and a second side, and the chip package is directly coupled to the first side of the signal cable. The antenna block is directly coupled to the second side of the signal cable.

Example 2 includes the subject matter of Example 1, wherein the signal cable comprises a liquid crystalline polymer.

Example 3 includes the subject matter of Example 1 or 2, wherein the chip package is directly coupled to the first side of the signal cable via a ball grid array.

Example 4 includes the subject matter of any one of Examples 1-3, wherein the antenna block is directly coupled to the second side of the signal cable via an adhesive.

Example 5 includes the subject matter of any one of Examples 1-3, wherein the antenna block is directly coupled to the second side of the signal cable via solder.

Example 6 includes the subject matter of any one of Examples 1-5, wherein the antenna block and the chip package are located opposite to one another along a length of the signal cable.

Example 7 includes the subject matter of any one of Examples 1-6, wherein the antenna block comprises a patch antenna.

Example 8 includes the subject matter of any one of Examples 1-7, wherein the signal cable comprises a plurality of conductor layers and one or more vias extending through the plurality of conductor layers.

Example 9 includes the subject matter of any one of Examples 1-8, and further comprising a second chip package comprising one or more circuit components, wherein the second chip package is directly coupled to the first side of the signal cable.

Example 10 includes the subject matter of any one of Examples 1-9, wherein the signal cable includes a plurality of surfaces, each having a first side and an opposite, parallel second side.

Example 11 includes the subject matter of claim 10, wherein a first surface of the plurality of surfaces includes one or more first antenna blocks operable over a first frequency range and a second surface of the plurality of surfaces includes one or more second antenna blocks operable over a second frequency range greater than the first frequency range.

Example 12 includes the subject matter of claim 11, and further comprising a second signal cable having a first surface with one or more first antenna blocks operable over a first frequency range and a second surface with one or more second antenna blocks operable over a second frequency range greater than the first frequency range, wherein the second signal cable is orientated at an angle between −90 degrees and +90 degrees with respect to the signal cable.

Example 13 includes the subject matter of any one of Examples 1-12, wherein the signal cable includes a ground plane that extends along a length of the signal cable beneath the antenna block.

Example 14 includes the subject matter of any one of Examples 1-13, wherein the chip package includes an RFIC chip having a surface that is coupled directly to an inner surface of a housing of the chip package.

Example 15 is a printed circuit board (PCB) or substrate comprising the RF transceiver device of any one of Examples 1-14.

Example 16 is a communication system comprising the RF transceiver device of any one of Examples 1-14, or the PCB or substrate of Example 15.

Example 17 is an RF system. The RF system includes a chip package comprising one or more circuit components, a board comprising one or more circuit components configured to process signals sent to the chip package or received from the chip package, a signal cable configured to carry signals sent to the chip package or received from the chip package, and an antenna block comprising one or more antennas. The signal cable has a first side and an opposite, parallel second side, and the chip package is directly coupled to the first side of the signal cable. The antenna block is directly coupled to the second side of the signal cable.

Example 18 includes the subject matter of Example 17, wherein the signal cable comprises a liquid crystalline polymer.

Example 19 includes the subject matter of Example 17 or 18, wherein the chip package is directly coupled to the first side of the signal cable via a ball grid array.

Example 20 includes the subject matter of any one of Examples 17-19, wherein the antenna block is directly coupled to the second side of the signal cable via an adhesive.

Example 21 includes the subject matter of any one of Examples 17-19, wherein the antenna block is directly coupled to the second side of the signal cable via solder.

Example 22 includes the subject matter of any one of Examples 17-21, wherein the antenna block and the chip package are located opposite to one another along a length of the signal cable.

Example 23 includes the subject matter of any one of Examples 17-22, and further comprising a second chip package comprising one or more circuit components, and a second signal cable configured to carry signals sent or received between the board and the second chip package. The second signal cable has a first side and an opposite, parallel second side, wherein the second chip package is directly coupled to the first side of the second signal cable.

Example 24 includes the subject matter of any one of Examples 17-23, wherein the signal cable comprises a plurality of conductor layers and one or more vias extending through the plurality of conductor layers.

Example 25 includes the subject matter of any one of Examples 17-24, wherein the antenna block comprises a patch antenna.

Example 26 includes the subject matter of any one of Examples 17-25, and further comprising a second chip package comprising one or more circuit components configured to transmit or receive RF signals, wherein the second chip package is directly coupled to the first side of the signal cable.

Example 27 includes the subject matter of any one of Examples 17-26, wherein the signal cable is bent such that the chip package is oriented at an angle with respect to the board.

Example 28 includes the subject matter of any one of Examples 17-27, wherein the signal cable includes a plurality of surfaces, each having a first side and an opposite, parallel second side.

Example 29 includes the subject matter of Example 28, wherein a first surface of the plurality of surfaces includes one or more first antenna blocks operable over a first frequency range and a second surface of the plurality of surfaces includes one or more second antenna blocks operable over a second frequency range greater than the first frequency range.

Example 30 includes the subject matter of Example 29, and further comprising a second signal cable having a first surface with one or more first antenna blocks operable over a first frequency range and a second surface with one or more second antenna blocks operable over a second frequency range greater than the first frequency range, wherein the second signal cable is orientated at an angle between −90 degrees and +90 degrees with respect to the signal cable.

Example 31 includes the subject matter of any one of Examples 17-30, wherein the signal cable includes a ground plane that extends along a length of the signal cable beneath the antenna block.

Example 32 includes the subject matter of any one of Examples 17-31, wherein the chip package includes an RFIC chip having a surface that is coupled directly to an inner surface of a housing of the chip package.

Example 33 is a printed circuit board (PCB) or substrate comprising the RF system of any one of Examples 17-32.

Example 34 is a communication apparatus comprising the RF system of any one of Examples 17-32, or the PCB or substrate of Example 33.

What is claimed is:

1. A radio frequency (RF) transceiver device, comprising:
a chip package comprising one or more circuit components;
a signal cable configured to carry signals sent to the chip package or received from the chip package, the signal cable having a first side and a second side, wherein the chip package is directly coupled to the first side of the signal cable; and
an antenna block comprising one or more antennas, the antenna block being directly coupled to the second side of the signal cable.

2. The RF transceiver device of claim 1, wherein the signal cable comprises a liquid crystalline polymer.

3. The RF transceiver device of claim 1, wherein the signal cable comprises a plurality of conductor layers and one or more vias extending through the plurality of conductor layers.

4. The RF transceiver device of claim 1, further comprising a second chip package comprising one or more circuit components, wherein the second chip package is directly coupled to the first side of the signal cable.

5. The RF transceiver device of claim 1, wherein the signal cable includes a plurality of surfaces, each having a first side and an opposite, parallel second side.

6. The RF transceiver of claim 5, wherein a first surface of the plurality of surfaces includes one or more first antenna blocks operable over a first frequency range and a second surface of the plurality of surfaces includes one or more second antenna blocks operable over a second frequency range greater than the first frequency range.

7. The RF transceiver of claim 6, further comprising a second signal cable having a first surface with one or more first antenna blocks operable over a first frequency range and a second surface with one or more second antenna blocks operable over a second frequency range greater than the first frequency range, wherein the second signal cable is orientated at an angle between −90 degrees and +90 degrees with respect to the signal cable.

8. The RF transceiver device of claim 1, wherein the signal cable includes a ground plane that extends along a length of the signal cable beneath the antenna block.

9. The RF transceiver device of claim 1, wherein the chip package includes an RFIC chip having a surface that is coupled directly to an inner surface of a housing of the chip package.

10. A printed circuit board (PCB) or substrate comprising the RF transceiver device of claim 1.

11. A radio frequency (RF) system, comprising:
a chip package comprising one or more circuit components;
a board comprising one or more circuit components configured to process signals sent to the chip package or received from the chip package;
a signal cable configured to carry the signals sent to the chip package or received from the chip package, the signal cable having a first side and an opposite, parallel second side, wherein the chip package is directly coupled to the first side of the signal cable; and
an antenna block comprising one or more antennas, the antenna block being directly coupled to the second side of the signal cable.

12. The RF system of claim 11, wherein the signal cable comprises a liquid crystalline polymer.

13. The RF system of claim 11, further comprising:
a second chip package comprising one or more circuit components; and
a second signal cable configured to carry signals sent or received between the board and the second chip package, the second signal cable having a first side and an opposite, parallel second side, wherein the second chip package is directly coupled to the first side of the second signal cable.

14. The RF system of claim 11, wherein the signal cable is bent such that the chip package is oriented at an angle with respect to the board.

15. The RF system of claim 11, wherein the signal cable includes a plurality of surfaces, each having a first side and an opposite, parallel second side.

16. The RF system of claim 15, wherein a first surface of the plurality of surfaces includes one or more first antenna blocks operable over a first frequency range and a second surface of the plurality of surfaces includes one or more second antenna blocks operable over a second frequency range greater than the first frequency range.

17. The RF system of claim 16, further comprising a second signal cable having a first surface with one or more first antenna blocks operable over a first frequency range and a second surface with one or more second antenna blocks operable over a second frequency range greater than the first frequency range, wherein the second signal cable is orientated at an angle between −90 degrees and +90 degrees with respect to the signal cable.

18. The RF system of claim 11, wherein the signal cable includes a ground plane that extends along a length of the signal cable beneath the antenna block.

19. The RF system of claim 11, wherein the chip package includes an RFIC chip having a surface that is coupled directly to an inner surface of a housing of the chip package.

20. A printed circuit board (PCB) or substrate comprising the RF system of claim 11.
